(19) United States
(12) Patent Application Publication
(10) Pub. No.: US 2011/0151270 A1
(43) Pub. Date: Jun. 23, 2011

(54) METHODS OF LASER ASSISTED PLASMA COATING AT ATMOSPHERIC PRESSURE AND SUPERALLOY SUBSTRATES COMPRISING COATINGS MADE USING THE SAME

(76) Inventors: Todd Jay Rockstroh, Cincinnati, OH (US); David N. Ruzic, Pesotum, IL (US); Bhupendra Kumar Gupta, Cincinnati, OH (US); Nripendra Nath Das, Cincinnati, OH (US)

(21) Appl. No.: 12/641,695

(22) Filed: Dec. 18, 2009

(51) Int. Cl. B32B 5/18; C23C 4/12; C23C 4/10; B32B 3/26; B32B 5/16; B32B 15/01

(52) U.S. Cl. 428/550; 427/453; 427/446; 428/312.8; 428/328; 428/329; 428/553

(57) ABSTRACT

Methods of laser assisted plasma coating at atmospheric pressure including providing a plasma, at least one target, at least one laser, and a superalloy substrate, operably directing the laser toward the target to liberate atomic particles from the target and feed the atomic particles into the plasma, and depositing the atomic particles onto the superalloy substrate using the plasma to produce a thermal barrier coating having a column width of from about 0.5 microns to about 60 microns, and an intra column porosity of from about 0% to about 9%.

### TECHNICAL FIELD

Embodiments described herein generally relate to methods of laser assisted plasma coating at atmospheric pressure and superalloy substrates comprising coatings made using the same.

### BACKGROUND OF THE INVENTION

Increasingly stringent demands are being imposed on the efficacy of gas turbine engines employed in the aerospace and power generation industries. This demand is driven by the requirement to reduce the consumption of fossil fuels, and in turn, operating costs. One way to improve turbine efficiency is to increase the operating temperature in the turbine section of the engine. However, with increased operating temperatures comes an increased demand on materials used in the turbine section. Not only must these materials be able to withstand the higher operating temperatures (from about 800° C. to about 1500° C.), but they must also endure increased mechanical stresses, corrosion, erosion, and other severe operating conditions, while continuing to fulfill lifetime requirements expected by the industry. This can be accomplished through the use of thermal barrier coatings (TBCs) applied to the high temperature component.

Conventional practices often utilize plasma spray or electron beam physical vapor deposition (EBPVD) to apply the high temperature TBCs, both of which can be problematic. For example, plasma spray can produce highly porous coatings having lower erosion and impact resistance than EBPVD. Such plasma sprayed coatings can be susceptible to plugging up the cooling holes of turbine components to which they are applied. While EBPVD can produce more desirable coatings, it is an expensive process because it is carried out under a high vacuum and has higher equipment costs.

Accordingly, there remains a need for manufacturing methods that are capable of producing coatings that are structurally similar to those resulting from EBPVD, without the costly vacuum and equipment requirements set forth previously.

### BRIEF DESCRIPTION OF THE INVENTION

Embodiments herein generally relate to methods of laser assisted plasma coating at atmospheric pressure comprising providing: a plasma; at least one target; at least one laser; and a superalloy substrate; operably directing the laser toward the target to liberate atomic particles from the target and feed the atomic particles into the plasma; and depositing the atomic particles onto the superalloy substrate using the plasma to produce a thermal barrier coating having a column width of from about 0.5 microns to about 60 microns, and an intra column porosity of from about 0% to about 9%.

Embodiments herein also generally relate to methods of laser assisted plasma coating at atmospheric pressure comprising providing: a plasma; two targets; two lasers; and a superalloy substrate; operably directing one of the lasers toward each of the targets to liberate atomic particles from the targets and feed the atomic particles into the plasma; and depositing the atomic particles onto the superalloy substrate using the plasma to produce a thermal barrier coating having a column width of from about 0.5 microns to about 60 microns, and an intra column porosity of from about 0% to about 9%.

Embodiments herein also generally relate to methods of laser assisted plasma coating at atmospheric pressure comprising providing: a plasma; two targets, a first target comprising zirconium oxide and a second target comprising yttrium oxide; two neodymium-doped yttrium aluminum garnet lasers; and a superalloy substrate comprising a nickel based superalloy or a cobalt based superalloy; operably directing one of the lasers toward each of the first target and the second target to liberate atomic particles from the targets and feed the atomic particles into the plasma; and depositing the atomic particles onto the superalloy substrate using the plasma to produce a thermal barrier coating comprising about 92% by weight zirconium oxide and about 8% by weight yttrium oxide, and having a column width of from about 0.5 microns to about 60 microns, and an intra column porosity of from about 0% to about 9%.

These and other features, aspects and advantages will become evident to those skilled in the art from the following disclosure.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements.

FIG. 1 is a schematic cross-sectional representation of one embodiment of a laser assisted plasma coating at atmospheric pressure (LAPCAP) system in accordance with the description herein; and

FIG. 2 is a schematic cross-sectional representation of an alternate embodiment of a LAPCAP system in accordance with the description herein.

### DETAILED DESCRIPTION OF THE INVENTION

Embodiments described herein generally relate to methods of laser assisted plasma coating at atmospheric pressure (LAPCAP) and superalloy substrates for use in high temperature environments comprising coatings made using the same. While the systems herein are designated “at atmospheric pressure,” they should not be limited to such. More specifically, the LAPCAP system may be utilized at near atmospheric pressure (e.g. about 0.5 Atm to about 3 Atm).

In general, the LAPCAP system involves using at least one pulsed laser to liberate atomic particles from at least one target, and then feeding those atomic particles into a plasma for deposition onto a substrate to form a thermal barrier coating. As used herein, “liberate” can refer to any of ablating, vaporizing, melting, or some combination thereof. While the coatings described herein may be used on any substrate exposed to high temperature environments (from about 800° C. to about 1500° C.), such coatings are particularly suited for use on components in the turbine section of a gas turbine engine.

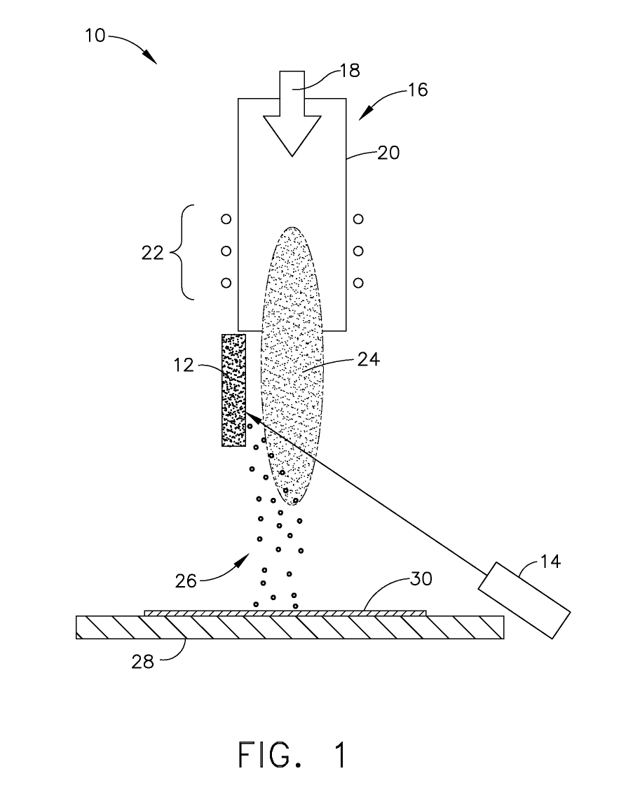

In one embodiment, and as shown in FIG. 1, LAPCAP system 10 can generally comprise a plasma torch 16, at least one target 12, and at least one laser 14. Plasma torch 16 can include a gas stream 18 that feeds into a discharge tube 20 having a plurality of inductively coupled plasma (ICP) coils 22 that can serve as a radio frequency generator, as set forth below.

More particularly, gas stream 18 can feed into discharge tube 20 to help generate plasma 24 and can comprise any gas suitable for carrying out conventional plasma spray processes, which in one embodiment, can be selected from argon, nitrogen, hydrogen, helium, oxygen, and combinations thereof. In particular, as gas stream 18 feeds into discharge tube 20, the radio frequency field generated by ICP coils 22 can be activated. As gas stream 18 passes through discharge tube 20, adjacent to ICP coils, gas stream 18 can become electrically conductive, and form plasma 24. At low flow rates (e.g. about 0.5 L/minute, for example) the plasma can be more stationary, whereas at higher gas flow rates (e.g. about 30 L/minute, for example) the plasma can take the form of a jet. It will be understood that a variety of flow rates, both above and below those provided herein, can also be utilized to alter the surface morphology and of the thermal barrier coatings. In an alternate embodiment, plasma 24 can be created by a microwave discharge (not shown) instead of, or in conjunction with, ICP coils 22.

Target 12 may comprise any material capable of being atomized by laser 14 and suitable for use as a thermal barrier coating, such as for example, ceramic materials and metallic materials. As used herein, “ceramic materials” can include zirconium oxide, yttrium oxide, alumina and pre-alloyed combinations thereof, while “metallic materials” may include zirconium, yttrium, aluminum, and combinations thereof.

In the embodiment shown in FIG. 1, target 12 can be positioned below discharge tube 20 of plasma torch 16, adjacent to plasma 24, and secured in place using any suitable means. In an alternate embodiment, target 12 can be placed inside of plasma torch 16, or be positioned to permit target 12 to replace and function as discharge tube 20. Laser 14 can be operably directed toward target 12 such that during operation, laser 14 can strike target 12 to liberate atomic particles 26, which can combine in the proper proportion in plasma 24 needed to make the desired TBC. Plasma 24 can then be used to accelerate and deposit atomic particles 26 onto substrate 28 as set forth below. When metallic materials are used as target 12, reactive gases, such as oxygen and nitrogen, can be used to oxidize or nitrodize the atomic particles to obtain the desired coating composition and properties. Such gases can be added to the LAPCAP system or come from the atmosphere.

Several varieties of solid state pulsed lasers having sufficient energy to liberate the atomic particles from the target can be utilized, including, but not limited to, neodymium-doped yttrium aluminum garnet (Nd:YAG) lasers. Because of the adjacency of target 12 to plasma 24, atomic particles 26 are fed into plasma 24 as they are liberated. Plasma 24 can then accelerate the atomic particles, forcing them onto substrate 28, where they can deposit as TBC 30. Variation in the combination of laser operating parameters, including laser pulse length, laser pulse energy, laser intensity, and laser spot size can allow the atomic particle flux and distribution to be tailored to achieve the desired coating composition and properties. Generally, pulsed laser 14 can have a pulse length of from about 5 femtoseconds to about 100 microseconds, a pulse energy of from about 0.001 mJ to about 10 J, an intensity of from about 10⁴ W/cm² to about 10¹⁵ W/cm², and a laser spot size ranging from about 1 micrometer to about 5 millimeters.

While a variety of substrates 28 can be used in conjunction with the embodiments herein, in one embodiment, substrate 28 may be selected from superalloys suitable for use in high temperature (from about 800° C. to about 1500° C.) environments, such as those present in the turbine section of a gas turbine engine. Some examples of such superalloys can include, but should not be limited to, nickel based superalloys, and cobalt based superalloys. In order to achieve the desired TBC 30 thickness, which can range from about 50 microns to about 750 microns, substrate 28 can be moved beneath a stationary LAPCAP system 10 to build up layers of TBC 30. In an alternate embodiment, substrate 28 can be stationary while the system 10 moves as needed using a pre-programmed robotic armature (not shown). The embodiments herein can result in the deposition of a TBC that has a columnar microstructure similar to that of coatings obtained using EBPVD. More specifically, the TBCs herein can have a column width of from about 0.5 microns to about 60 microns, and an intra column porosity of from about 0% to about 9%. In one embodiment, the TBC can comprise smaller diameter columns and about 0% porosity.

In an alternate embodiment, more than one target and more than one laser can be used. As used here, “lasers” can refer to either multiple independent lasers, or alternately, one laser split into multiple beams. In such instances, each target may comprise the same or different materials (such as in the exemplary embodiment below). It will be understood that one laser, i.e. either an independent laser, or a split laser beam, can be operably directed toward each target to liberate atomic particles therefrom.

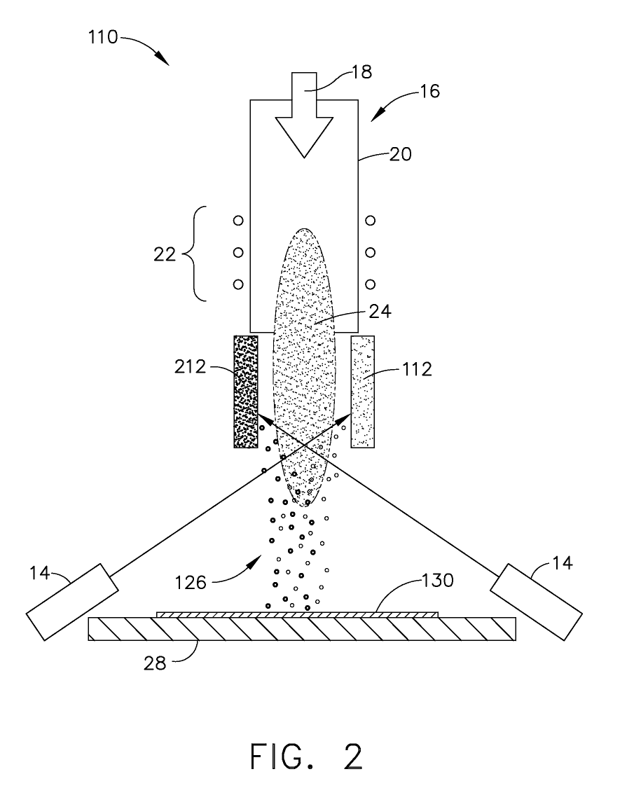

By way of example and not limitation, and as shown in FIG. 2, LAPCAP system 110 can comprise a gas stream 18, which in one embodiment can be argon, two pulsed Nd:YAG lasers 14, two targets comprising ceramic materials, a first target 112 comprising ZrO₂, and a second target 212 comprising Y₂O₃. Gas stream 18 can comprise a gas flow of from about 0.05 L/minute to about 0.6 L/minute. In this embodiment, pulsed lasers 14 can have a pulse length of from about 5 ns to about 10 ns, a pulse energy of about 10 mJ, an intensity of from about 10⁷ to about 10⁸ W/cm², and a laser spot size ranging from about 1 micrometer to about 2 millimeters. This particular combination of laser operating parameters can liberate atomic particles 126 of zirconium, oxygen, and yttria, which can be deposited onto a combination nickel based, and cobalt based, superalloy substrate 28 as a thermal barrier coating 130 comprising about 92% by weight ZrO₂ and about 8% by weight Y₂O₃ and having a thickness of from about 50 microns to about 750 microns. Those skilled in the art will understand that this is an example of one possible system and that other systems of varying parameters are within the scope of the present embodiments.

The embodiments described herein differ from conventional processes. Particularly, unlike EBPVD, LAPCAP does not require the use of costly vacuum pumps, and particle generation, acceleration, and deposition can be accomplished using a single apparatus. However, in spite of these differences, LAPCAP can produce coatings having a columnar microstructure that is similar to coatings made using EBPVD. This is possible since LAPCAP deposition occurs on an atomic level. The result is a TBC that can be less susceptible to impact and erosion damage than coatings produced using conventional plasma spray processes. Additionally, the clogging of cooling holes that can occur with plasma spray can be greatly reduced or eliminated using LAPCAP.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of laser assisted coating at atmospheric pressure comprising:
providing: a plasma;
at least one target;
at least one laser; and
a superalloy substrate;
operably directing the laser toward the target to liberate atomic particles from the target and feed the atomic particles into the plasma; and
depositing the atomic particles onto the superalloy substrate using the plasma to produce a thermal barrier coating having a column width of from about 0.5 microns to about 60 microns, and an intra column porosity of from about 0% to about 9%.

2. The method of claim 1 wherein the target comprises a ceramic material selected from the group consisting of zirconium oxide, yttrium oxide, alumina, and pre-alloyed combinations thereof; or a metallic material selected from the group consisting of zirconium, yttrium, aluminum, and combinations thereof.

3. The method of claim 2 wherein the laser comprises a solid state pulsed laser.

4. The method of claim 3 comprising tailoring the thermal barrier coating by varying any one or more operating parameter selected from a laser pulse length of from about 5 femtoseconds to about 100 microseconds; a laser pulse energy of from about 0.001 mJ to about 10 J; a laser intensity of from about 10⁴ W/cm² to about 10¹⁵ W/cm²; and a laser spot size of from about 1 micrometer to about 5 millimeters.

5. The method of claim 4 comprising applying the thermal barrier coating to a thickness of from about 50 microns to about 750 microns.

6. The method of claim 5 wherein the superalloy substrate is a nickel based superalloy or a cobalt based superalloy.

7. The method of claim 6 comprising generating the plasma using a plasma torch having a gas stream comprising a gas selected from the group consisting of argon, nitrogen, hydrogen, helium, oxygen, and combinations thereof wherein the gas stream is activated by a plurality of inductively coupled plasma coils, or a microwave.

8. A superalloy substrate comprising the thermal barrier coating made by the method of claim 7.

9. A method of laser assisted coating at atmospheric pressure comprising:
providing: a plasma;
two targets;
two lasers; and
a superalloy substrate;
operably directing one of the lasers toward each of the targets to liberate atomic particles from the targets and feed the atomic particles into the plasma; and
depositing the atomic particles onto the superalloy substrate using the plasma to produce a thermal barrier coating having a column width of from about 0.5 microns to about 60 microns, and an intra column porosity of from about 0% to about 9%.

10. The method of claim 9 wherein each target comprises a ceramic material selected from the group consisting of zirconium oxide, yttrium oxide, alumina, and pre-alloyed combinations thereof; or a metallic material selected from zirconium, yttrium, aluminum, and combinations thereof.

11. The method of claim 10 wherein the lasers comprise solid state pulse lasers.

12. The method of claim 11 comprising tailoring the thermal barrier coating by varying any one or more operating parameter selected from a laser pulse length of from about 5 femtoseconds to about 100 microseconds; a laser pulse energy of from about 0.001 mJ to about 10 J; a laser intensity of from about 10⁴ W/cm² to about 10¹⁵ W/cm²; and a laser spot size of from about 1 micrometer to about 2 millimeters.

13. The method of claim 12 wherein the superalloy substrate is a nickel based superalloy or a cobalt based superalloy.

14. The method of claim 13 wherein the targets comprise the same materials.

15. The method of claim 14 comprising generating the plasma using a plasma torch having a gas stream comprising a gas selected from the group consisting of argon, nitrogen, hydrogen, helium, oxygen, and combinations thereof wherein the gas stream is activated by a plurality of inductively coupled plasma coils, or a microwave.

16. A superalloy substrate comprising the thermal barrier coating made by the method of claim 15.

17. A method of laser assisted coating at atmospheric pressure comprising:
providing: a plasma;
two targets, a first target comprising zirconium oxide and a second target comprising yttrium oxide;
two neodymium-doped yttrium aluminum garnet lasers; and
a superalloy substrate comprising a nickel based superalloy or a cobalt based superalloy;
operably directing one of the lasers toward each of the first target and the second target to liberate atomic particles from the targets and feed the atomic particles into the plasma; and
depositing the atomic particles onto the superalloy substrate using the plasma to produce a thermal barrier coating comprising about 92% by weight zirconium oxide and about 8% by weight yttrium oxide, and having a column width of from about 0.5 microns to about 60 microns, and an intra column porosity of from about 0% to about 9%.

18. The method of claim 17 comprising generating the plasma using a plasma torch having a gas stream comprising a gas selected from the group consisting of argon, nitrogen, hydrogen, helium, oxygen, and combinations thereof.

19. The method of claim 18 wherein the gas stream is activated by a plurality of inductively coupled plasma coils, or a microwave.

20. A superalloy substrate comprising the thermal barrier coating made by the method of claim 19.
